(19) United States
(12) Patent Application Publication
(10) Pub. No.: US 2014/0296457 A1
(43) Pub. Date: Oct. 2, 2014

(54) CATALYST PRECURSOR AND CATALYST FOR THE POLYMERISATION OF ETHYLENE

(71) Applicant: Saudi Basic Industries Corporation, RIYADH (SA)

(72) Inventors: Godefridus Arnoldus Henricus Nooijen, Panningen (NL); Matthijs Van Kessel, Oirsbeek (NL); Henricus Maria Antonius Stiphout, Roermond (NL)

(21) Appl. No.: 14/353,449

(22) PCT Filed: Oct. 23, 2012
(86) PCT No.: PCT/EP2012/004426

§ 371 Date: Apr. 22, 2014

(30) Foreign Application Priority Data
Oct. 26, 2011 (EP) 11075238.3

(51) Int. Cl. C08F 110/02

(52) U.S. Cl. CPC C08F 110/02
USPC 526/154; 502/171

(57) ABSTRACT

The invention is directed to a catalyst precursor for an ethylene polymerization catalyst comprising a porous inogranic support material carrying a chromium salt and an aluminium chelate. The aluminium chelate is aluminium di(C₁-C₁₀ alkoxide)acetoacetic ester chelate for example is aluminium di(sec-butoxide)ethylacetoacetate. The chromium salt is a chromium carboxylate for example chromium (III) acetate hydroxide. The porous inorganic support material is a silica support.

The invention relates to a catalyst precursor and a catalyst for the polymerisation of ethylene based on this precursor.

The production process to obtain high density polyethylene (HDPE) with chromium oxide catalysts is disclosed in “Handbook of Polyethylene” by Andrew Peacock (2000; Dekker; ISBN 0824795466) at pages 61-66. The slurry polymerization process for the preparation of the ethylene copolymers may take place by polymerizing ethylene and if desired olefin comonomer having between three and ten carbon atoms per molecule in the presence of a silica-supported chromium-containing catalyst.

The use of chromium compounds in the polymerization of olefins is disclosed in U.S. Pat. No. 2,825,721 and U.S. Pat. No. 2,951,816. The patents disclose the use of CrO₃ supported on an inorganic material for example silica and/or alumina and the activation by heating at elevated temperatures to polymerise an olefin. The polymers produced with these catalysts are unsatisfactory because of a deficiency in certain properties for example melt index.

It is a problem to produce a polymer with a relatively higher melt index (lower MW) because these silica supported chromium catalysts are much less sensitive to hydrogen (compared e.g. to Z/N catalysts) and the polymerization temperature has to be increased to produce a higher melt index. However when the polymerization temperature is increased too much, the polymer particles start to swell and become sticky resulting in fouling of the reactor. So there is a need to increase the melt index of polyethylene produced with silica supported chromium catalysts. Several routes to increase the melt index of polyethylene produced with silica supported chromium catalysts are known. One route is to use a support with higher pore volume and another route is to add an extra metal for example aluminium to the catalyst precursor. Even better results are achieved with a combination of both routes by using a catalyst precursor consisting of a chromium compound and an aluminium compound supported on a high pore volume silica support.

During production of the catalyst precursor the high pore volume support is normally impregnated with a solution of the chromium compound and the aluminium compound. After the impregnation step, the solvent has to be removed by drying the catalyst precursor. When water is used as solvent, the high pore volume of the support cannot be preserved because the pores would partially collapse during the drying step due to the high surface tension of water. This problem can be solved by using organic solvents for example alkanes, ketones and/or alcohols. However, the solubility of suitable chromium compounds and aluminium compounds in these organic solvents is usually not very high which makes it difficult to produce catalyst precursors with the desired levels of chromium and aluminium without using uneconomical methods like multiple step impregnations or large amounts of solvent.

U.S. Pat. No. 3,984,351 discloses high pore volume silica supported chromium and aluminium containing catalysts for production of HDPE with increased melt index. The preferred organic solvent is dichloromethane and in the preferred method the support slurry is impregnated first with a solution of the chromium compound and next with a solution of the aluminium compound.

It is more economical to impregnate the support with chromium and aluminium together in a one step impregnation. It is also more economical to use the so called incipient wetness impregnation in stead of a slurry impregnation. Incipient wetness impregnation means that the amount of solvent used to impregnate a certain amount of support is not more than the total pore volume of that support. A one step incipient wetness impregnation also guarantees a more homogeneous distribution of the chromium and the aluminium on the support particles compared to a two step slurry impregnation.

There is a need to increase the solubility of chromium and aluminium compounds in organic solvents in order to produce high pore volume silica supported Cr/Al catalyst precursors via a one step incipient wetness impregnation. Although the Al in the catalyst of U.S. Pat. No. 3,984,351 increases the MI potential the MI is limited for the same process reasons as before. Consequently there is a continuing need to increase MI.

GB 1575352 discloses the simultaneous impregnation of a porous inorganic support material slurry with both chromium compound and a metal compound of Group IIA or IIIA of the Periodic Table of Elements from aliphatic and/or cyclo aliphatic solutions. However, the solubility the mixed chromium compound and metal compound of Group IIA or IIIA of the Periodic Table of Elements is too low for a one step incipient wetness impregnation and therefore uneconomical large amounts of aliphatic and/or cycloaliphatic solutions are used in slurry phase impregnation. Besides this, the metal compound of Group IIA or IIIA of the Periodic Table of Elements used in GB1575352 are metal alkyl compounds which react violently with oxygen and water and special precautions are necessary for safe production of the catalyst precursor. The metal alkyl like for example aluminium trialkyl reacts with the chromium compound and forms a soluble Cr/Al complex which still contains highly reactive alkyl groups that can react with the hydroxyl groups on the silica support during impregnation. The highly reactive Cr/Al complex, in combination with the slurry phase impregnation, can result in an inhomogeneous distribution of the Cr/Al metals in the silica support particles. The reason for this is that the reactive Cr/Al complex is not able to migrate into the inner pore structure of the support particles because of its fast reaction with the outer hydroxyl groups on the silica. This may lead to smaller support particles carrying higher concentrations of the chromium and aluminium than larger support particles, leading to potentially less effective utilisation of the catalytically active surfaces during polymerization.

There is a continuing need to increase the solubility of chromium and alkyl free aluminium compounds in organic solvents in order to produce high pore volume silica supported Cr/Al catalyst precursors via a one step incipient wetness impregnation. Although the Al in the catalyst of GB1575352 increases the MI potential the MI is limited for the same process reasons as before. Consequently there is a continuing need to increase MI.

WO 2009/053672 discloses a method to produce a Cr/Al catalyst in a one-step incipient wetness impregnation process. In this method, the solubility of the Al compound is increased by adding boric acid. It is a problem that the boric acid has no further catalytic function and will stay behind in the produced polymer and can be regarded as polymer “pollution”. Although the Al in the catalyst of WO2009/053672 increases the MI potential the MI is limited for the same process reasons as before. Consequently there is a continuing need to increase MI.

It is the object of the present invention to produce high pore volume silica supported Cr/Al catalyst precursors without the use of metal alkyls or polymer polluting solubility enhancer compounds.

The invention is characterised in that the catalyst precursor comprises a porous inorganic support material carrying a chromium salt and an aluminium chelate wherein the aluminium chelate is an aluminium di (C₁-C₁₀ alkoxide)acetoacetic ester chelate according to the formula

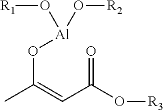

wherein R₁, R₂ and R₃ are alkyl groups with C₁-C₁₀ carbon atoms.

This precursor results in the production of high pore volume silica supported Cr/Al catalyst precursors, for example via a one step incipient wetness impregnation, without the use of metal alkyls or polymer polluting solubility enhancer compounds. Consequently, the precursor does not comprise boric acid.

A further advantage of the catalyst according to the present invention is that the polyethylene obtained with the catalyst has an increased melt index (MI).

Another advantage is that the activated Cr/Al catalyst contains a higher amount of Cr⁶⁺ at higher activation temperatures, for example higher than 700 degrees Celsius, and has higher activity.

Suitable aluminium di(C₁-C₁₀ alkoxide)acetoacetic ester chelates include aluminium di(sec-butoxide)aceto acetic ester chelate and di(isopropoxide)acetoacetic ester chelate.

According to a preferred embodiment of the invention the aluminium chelate is aluminium di(sec-butoxide)ethylacetoacetate with the formula:

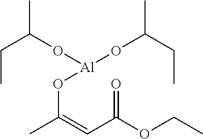

The amount of aluminium in the catalyst is generally at least 0.25% by weight.

According to a preferred embodiment of the invention the amount of aluminium in the catalyst ranges between 0.5 wt % and 5.0 wt %.

Suitable examples of inorganic porous support materials include oxides for example silica, alumina, clay, aluminium phosphates, mixed silica-alumina, mixed silica-clay, or oxides of zirconium, thorium or magnesium.

According to a preferred embodiment of the invention the porous inorganic support is a silica support. The silica support may be a silica xerogel.

The silica may have a surface area (SA) larger than 200 m²/g and a pore volume (PV) larger than 0.8 cm³/g.

The amount of chromium in the catalyst is generally at least 0.2% by weight.

Preferably the amount of chromium in the catalyst is at least 0.5 wt % but not more than 2.0 wt %.

According to a preferred embodiment of the invention the amount of chromium in the catalyst ranges between 0.2 and 2.0% by weight.

Preferably the chromium salt is a chromium carboxylate. It is also possible to apply any appropriate chromium salt that is soluble in an alcohol like methanol.

According to a preferred embodiment of the invention the chromium carboxylate is chromium acetate.

According to a further preferred embodiment of the invention the chromium acetate is chromium (III) acetate hydroxide (CAS nr. 39430-51-8; Cr₃(OH)₂(CH₃CO₂)₇).

According to a preferred embodiment of the invention the average particle size (D₅₀) of the inorganic support is between 25 and 150 micrometers.

Generally, the catalyst is activated before being applied in the polymerization reaction. The activation may take place under different conditions. The activation generally takes place at an elevated temperature, for example, at a temperature above 450° C. The activation may take place in different atmospheres, for example in dry air.

Generally the activation takes place at least partially under an inert atmosphere. Generally the inert atmosphere is a nitrogen atmosphere. At the same time the temperature is raised slowly. It has been found to be advantageous to change from the nitrogen atmosphere to an atmosphere of dry air at a temperature of at most 700° C. The activation time after reaching the maximum temperature may last for several minutes to several hours. Generally this activation time is at least 15 minutes but it may be advantageous to activate during a longer period. After activation the dry air in the catalyst is removed by purging with an inert gas like nitrogen. Generally, after activation of the catalyst, it is cooled to ambient temperature and stored ready for use in polymerization.

After activation of the catalyst precursor in dry air the Cr (III) that is present in the catalyst precursor will have been completely or partially oxidized to Cr (VI). The higher the temperature used in the activation process, the lower the amount of Cr(VI) in the catalyst will be. The catalyst, activated under the specific conditions, with a high Cr (VI) content will generally be more active then a catalyst with a lower Cr (VI) content that has been activated under the same conditions because Cr (VI) is the precursor of the actual polymerization sites.

According to a preferred embodiment of the invention the process for preparing a catalyst precursor for an ethylene polymerization catalyst comprises the steps:
a) providing a porous inorganic support material,
b) depositing a chromium salt and an aluminium chelate according to the formula

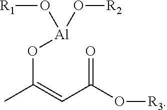

wherein R₁, R₂ and R₃ are alkyl groups with C₁-C₁₀ carbon atoms onto the porous inorganic support material from an alcoholic solution wherein the volume of the alcoholic solution is less than the total pore volume of that porous inorganic support material and
c) removing the alcohol by evaporation to form the catalyst precursor.

Preferably the alcoholic solution is a C₁-C₄ alcohol.

Preferably the alcohol is methanol.

According to a further preferred embodiment of the invention the process for preparing a catalyst precursor for an ethylene polymerization catalyst comprises the steps:
a) providing a porous inorganic support material,
b) depositing a chromium salt and an aluminium di(C₁-C₁₀ alkoxide) acetoacetic ester chelate onto the porous inorganic support material from a methanol solution wherein the volume of the methanol solution is less than the total pore volume of that porous inorganic support material and
c) removing the methanol by evaporation to form the catalyst precursor.

In this process to produce the catalyst precursor by impregnating a porous inorganic support with a chromium compound and an aluminium compound in a one step incipient wetness process using an alcoholic solution of the chromium and aluminium compound the porous inorganic support material is preferably a silica xerogel with a pore volume from 0.8 to 4.0 cm³/g and a surface area from 200 to 800 m²/g.

The preferred chromium salt is chromium (III) acetate hydroxide and the preferred aluminium di(C₁-C₁₀ alkoxide)acetoacetic ester chelate is aluminium di(sec-butoxide)ethylacetoacetate.

The ethylene polymerization catalyst may be obtained by heating the catalyst precursor in a non-reducing atmosphere at a temperature in the range between 450 and 1000° C. for a time period in the range between 15 minutes and 30 hours.

The polymerization may be performed via a slurry phase polymerisation process. This process is disclosed for example in Handbook of Polyethylenes by Andrew Peacock, 2000, pages 61-66.

The catalyst prepared using the invention may be used in a variety of homo- or co-polymerisation routes for the production of polyethylenes, by process routes such as solution, slurry-loop or gas phase polymerisation. Ethylene or mixtures of ethylene with C₃ to C₈ [alpha]-alkenes may be used in the polymerisations. The catalyst may be applied in the polymerisation of C₂ to C₈ [alpha]-alkenes.

Preferably, the polymerization of ethylene takes place in a diluent at a temperature of between 90° C. and 110° C. Hydrogen can be used in the polymerization process of the present invention for example to control melt flow index, die swell as well as elasticity of the polymer products.

Suitable diluents include paraffins, cycloparaffins and/or aromatic hydrocarbons such as for example isobutane and propane.

Co-catalysts may be used in combination with the catalysts prepared from the precursors of the invention. Suitable co-catalysts are aliphatic or alicyclic boron compounds for example triethyl borane, tri-n-butyl borane, triisobutyl borane, tri-n-propyl borane, tri-n-octyl borane,trimethyl borane, tri-sec-butyl borane, tri-isopropyl borane, trihexyl borane, tripentyl borane, triphenyl borane, tribenzyl borane, tridecyl borane tridodecyl borane, diethyl boron ethoxide and/or diethyl boron methoxide.

Generally the aliphatic or alicyclic boron compound having at least one boron to carbon linkage is a (C₁-C₁₂)alkyl boron compound for example triethyl borane (TEB). Generally the boron concentration in the polymerization reactor is less than 5.0 ppm of boron based on the diluent.

An anti static agent can be used to suppress fouling of the polymerization reactor wall. Examples of suitable anti static agents are disclosed in U.S. Pat. No. 4,182,810, EP107127 A1 or Research Disclosure 515018.

The ethylene polymers or copolymers obtained with the catalyst according to the invention may be extruded or blow-moulded into articles such as for example bottles, containers, fuel tanks and drums, or may be extruded or blown into films.

The ethylene polymers or copolymers obtained with the process according to the invention may be combined with additives such as for example lubricants, fillers, stabilizers, antioxidants, compatibilizers and pigments. The additives used to stabilize the copolymers may be, for example, additive packages including hindered phenols, phosphites, UV stabilisers, antistatics and stearates.

The invention will be elucidated by means of the following non-limiting examples.

### EXAMPLES I-V AND COMPARATIVE EXAMPLES A-E

### Preparation of Chromium and Aluminium Containing Catalyst Precursors

Examples I-II show the preparation of the catalyst precursor according to the invention. All catalyst precursors produced in Examples I-II and Comparative Examples A-B contained about 1.1 wt % chromium and about 2.6 wt % aluminium.

### Example I

6.93 grams of chromium(III)acetate hydroxide (CAS nr. 39430-51-8; Cr₃(OH)₂(CH₃CO₂)₇) and 47.5 grams of aluminium di(sec-butoxide)ethyl acetoacetate (CAS nr. 24772-51-8; C₁₄H₂₇AlO₅) were stirred for 1 hour in 400 ml methanol so that the chromium and aluminium compounds were dissolved.

100 grams of a silica support with a pore volume of 2.73 cm³/g, an average particle size (D₅₀) of 69.4 micrometers and a surface area of 395 m²/g was fluidized with nitrogen gas in a fluid bed at room temperature.

246 ml of the methanol solution containing the chromium and aluminium compounds was sprayed on the silica with 30 ml per minute. Finally, the methanol was removed from the catalyst precursor by drying in a vacuum oven at 100° C. for 6 hours.

### Comparative Example A

6.93 grams of chromium(III)acetate hydroxide (CAS nr. 39430-51-8; Cr₃(OH)₂(CH₃CO₂)₇) and 22.04 grams of boric acid stabilized dibasic aluminium acetate (CAS nr. 7360-44-3; (CH₃CO₂)Al(OH)₂.⅓H₃BO₃) were stirred for 1 hour in 400 ml methanol so that the chromium and aluminium compounds were dissolved.

100 grams of a silica support with a pore volume of 2.73 cm³/g, an average particle size (D₅₀) of 69.4 micrometers and a surface area of 395 m²/g was fluidized with nitrogen gas in a fluid bed at room temperature.

246 ml of the methanol solution containing the chromium and aluminium compounds was sprayed on the silica with 30 ml per minute. Finally, the methanol was removed from the catalyst precursor by drying in a vacuum oven at 100° C. for 6 hours.

### Example II

7.41 grams of chromium(III)acetate hydroxide (CAS nr. 39430-51-8; Cr₃(OH)₂(CH₃CO₂)₇) and 50.8 grams of aluminium di(sec-butoxide)ethylacetoacetate (CAS nr. 24772-51-8; C₁₄H₂₇AlO₅) were stirred for 1 hour in 400 ml methanol so that the chromium and aluminium compounds were dissolved.

100 grams of a silica support with a pore volume of 3.09 cm³/g, an average particle size (D₅₀) of 89.1 micrometers and a surface area of 407 m²/g was fluidized with nitrogen gas in a fluid bed at room temperature.

230 ml of the methanol solution containing the chromium and aluminium compounds was sprayed on the silica with 30 ml per minute. Finally, the methanol was removed from the catalyst precursor by drying in a vacuum oven at 100° C. for 6 hours

### Comparative Example B

7.41 grams of chromium(III)acetate hydroxide (CAS nr. 39430-51-8; Cr₃(OH)₂(CH₃CO₂)₇) and 23.60 grams of boric acid stabilized dibasic aluminium acetate (CAS nr. 7360-44-3; (CH₃CO₂)A1(OH)₂.⅓H₃BO₃) were stirred for 1 hour in 400 ml methanol so that the chromium and aluminium compounds were dissolved.

100 grams of a silica support with a pore volume of 3.09 cm³/g, an average particle size (D₅₀) of 89.1 micrometers and a surface area of 407 m²/g was fluidized with nitrogen gas in a fluid bed at room temperature.

230 ml of the methanol solution containing the chromium and aluminium compounds was sprayed on the silica with 30 ml per minute. Finally, the methanol was removed from the catalyst precursor by drying in a vacuum oven at 100° C. for 6 hours.

### Activation of the Catalyst Precursors and Polymerization

The characteristics of polyethylene obtained in the following examples were determined as follows:
The high-load melt index (HLMI) of polyethylene was measured according to ISO 1133 on pellets at 190° C. with a test weight of 21.6 kg.
The density of polyethylene was measured according to ISO 1183 (with additional annealing step) (30 minutes boiling and cooling in water).

### Example III

Chromium catalyst precursor produced in Example I was first activated in a fluid bed in dry air (water content less than 1 ppm) at 600° C. for 4 hours. Nitrogen was used instead of dry air during the heating up and cooling down phases at temperatures lower than 320° C.

This catalyst was used to copolymerize ethylene and 1-butene in a continuously operated 5 L liquid-filled CSTR reactor in isobutane at 4.6 MPa. Triethylboron (TEB) was used as co-catalyst.

Isobutane (2,746 kg/h), ethylene (1,223 kg/h), 1-butene (4 g/h) and hydrogen (2.11 g/h) were continuously fed to the reactor at 103.0° C. TEB was also continuously fed to the reactor in such an amount that concentration of boron in the isobutane was 0.10 ppm.

The catalyst feed to the reactor was controlled in order to maintain a constant ethylene concentration in the reactor of 9.4 mol %.

Polyethylene production was 1 kg/h.

The catalyst activity was 330 g of polyethylene per g of catalyst per mol % ethylene.

After stabilization, the polymer reactor powder was pelletized in a twin-screw extruder.

The polyethylene pellets had the following characteristics:
Density: 956.8 kg/m³
High-load melt index: 19.1 dg/min

### Comparative Example C

Chromium catalyst precursor produced in Comparative Example A was first activated in a fluid bed in dry air (water content less than 1 ppm) at 600° C. for 4 hours. Nitrogen was used instead of dry air during the heating up and cooling down phases at temperatures lower than 320° C.

This catalyst was used to copolymerize ethylene and 1-butene in a continuously operated 5 L liquid-filled CSTR reactor in isobutane at 4.6 MPa Triethylboron (TEB) was used as co-catalyst. Isobutane (2,779 kg/h), ethylene (1,238 kg/h), 1-butene (4 g/h) and hydrogen (2.14 g/h) were continuously fed to the reactor at 104.0° C. TEB was also continuously fed to the reactor in such an amount that concentration of boron in the isobutane was 0.10 ppm.

The catalyst feed to the reactor was controlled in order to maintain a constant ethylene concentration in the reactor of 11.4 mol %. Polyethylene production was 1 kg/h.

The catalyst activity was 259 g of polyethylene per g of catalyst per mol % ethylene.

After stabilization, the polymer reactor powder was pelletized in a twin-screw extruder.

The polyethylene pellets had the following characteristics:
Density: 957.3 kg/m³
High-load melt index: 19.0 dg/min

Examples III and Comparative Example C clearly show that the catalyst of the invention has higher catalyst activity. Melt index capability is also higher because the same high-load melt index was produced at lower polymerization temperature.

### Example IV

Chromium catalyst precursor produced in Example I was first activated in a fluid bed in dry air (water content less than 1 ppm) at 820° C. for 15 minutes. Nitrogen was used instead of dry air during the heating up and cooling down phases at temperatures lower than 320° C. The activated catalyst contained 0.52 wt % Cr⁶⁺.

This catalyst was used to copolymerize ethylene and 1-butene in a continuously operated 5L liquid-filled CSTR reactor in isobutane at 4.6 MPa. Triethylboron (TEB) was used as co-catalyst.

Isobutane (2,766 kg/h), ethylene (1,238 kg/h), 1-butene (8.0 g/h) and hydrogen (2.14 g/h) were continuously fed to the reactor and polymerization temperature was controlled at 98.0° C. TEB was also continuously fed to the reactor in such an amount that concentration of boron in the isobutane was 0.20 ppm.

The catalyst feed to the reactor was controlled in order to maintain a constant ethylene concentration in the reactor of 10.2 mol %. Polyethylene production was 1 kg/h.

The catalyst productivity was 3450 g of polyethylene per g of catalyst. After stabilization, the polymer reactor powder was pelletized in a twin-screw extruder.

The polyethylene pellets had the following characteristics:
Density: 954.0 kg/m³
High-load melt index: 21.8 dg/min

### Comparative Example D

Chromium catalyst precursor produced in Comparative Example A was first activated in a fluid bed in dry air (water content less than 1 ppm) at 820° C. for 15 minutes. Nitrogen was used instead of dry air during the heating up and cooling down phases at temperatures lower than 320° C. The activated catalyst contained 0.37 wt % Cr⁶⁺.

This catalyst was used to copolymerize ethylene and 1-butene in a continuously operated 5L liquid-filled CSTR reactor in isobutane at 4.6 MPa. Triethylboron (TEB) was used as co-catalyst.

Isobutane (2,766 kg/h), ethylene (1,238 kg/h), 1-butene (8.0 g/h) and hydrogen (2.14 g/h) were continuously fed to the reactor and polymerization temperature was controlled at 98.5° C. TEB was also continuously fed to the reactor in such an amount that concentration of boron in the isobutane was 0.20 ppm.

The catalyst feed to the reactor was controlled in order to maintain a constant ethylene concentration in the reactor of 10.2 mol %. Polyethylene production was 1 kg/h.

The catalyst productivity was 2700 g of polyethylene per g of catalyst. After stabilization, the polymer reactor powder was pelletized in a twin-screw extruder.

The polyethylene pellets had the following characteristics:
Density: 954.3 kg/m³
High-load melt index: 21.7 dg/min

Example IV and Comparative Example D clearly show that the catalyst of the invention has higher Cr⁶⁺ content and higher catalyst productivity. Melt index capability is also higher because the same high-load melt index was produced at lower polymerization temperature.

### Example V

Chromium catalyst precursor produced in Example II was activated in a fluid bed in dry air (water content less than 1 ppm) at 800° C. for 8 hours. Nitrogen was used instead of dry air during the heating up and cooling down phases at temperatures lower than 320° C. The activated catalyst contained 0.65 wt % Cr⁶⁺.

0.169 grams of this catalyst was transferred into a 5 litre isobutane slurry batch reactor and tested under homopolymerization conditions using ethylene. Total reactor pressure was 37 bar. Hydrogen partial pressure was 6.1 bar and ethylene partial pressure was 9.4 bar. The reactor pressure was maintained at 37 bar by supplying ethylene. The polymerization temperature was maintained at 101° C. TEB was used in such an amount that concentration of boron in the isobutane was 0.06 ppm.

After 41 minutes 478 g polyethylene was produced and the productivity was 4100 g of polyethylene per g catalyst per hour.

The polymer had a melt index (5 kg) of 3.49 dg/min and a high load melt index of 63.1 dg/min.

### Comparative Example E

Chromium catalyst precursor produced in Comparative Example B was first activated in a fluid bed in dry air (water content less than 1 ppm) at 800° C. for 8 hours. Nitrogen was used instead of dry air during the heating up and cooling down phases at temperatures lower than 320° C. The activated catalyst contained 0.52 wt % Cr⁶⁺.

0.176 grams of this catalyst was transferred into a 5 litre isobutane slurry batch reactor and tested under homopolymerization conditions using ethylene. Total reactor pressure was 37 bar. Hydrogen partial pressure was 6.1 bar and ethylene partial pressure was 9.4 bar. The reactor pressure was maintained at 37 bar by supplying ethylene. The reactor temperature was maintained at 101° C. TEB was used in such an amount that concentration of boron in the isobutane was 0.06 ppm. After 50 minutes 454 g polyethylene was produced and the catalyst productivity was 3100 g of polyethylene per g catalyst per hour.

The polymer had a melt index (5 kg) of 2.44 dg/min and a high load melt index of 43.9 dg/min.

Example V and Comparative Example E clearly show that the catalyst of the invention has higher Cr⁶⁺ content, higher activity and produces polymer with higher melt indexes.

1. A catalyst precursor for an ethylene polymerization catalyst comprising a porous inorganic support material carrying a chromium salt and an aluminium chelate wherein the aluminium chelate is aluminium di (C₁-C₁₀ alkoxide)acetoacetic ester chelate according to the formula 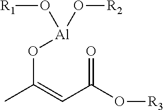
wherein R₁, R₂ and R₃ are alkyl groups with C₁-C₁₀ carbon atoms.

2. A catalyst precursor according to claim 1 characterised in that the aluminium di (C₁-C₁₀ alkoxide)acetoacetic ester chelate is aluminium di(sec-butoxide)ethylacetoacetate.

3. A catalyst precursor according to claim 1 characterised in that the chromium salt is a chromium carboxylate.

4. A catalyst precursor according to claim 3 characterised in that the chromium carboxylate is chromium acetate.

5. A catalyst precursor according to claim 4 characterised in that the chromium acetate is chromium (III) acetate hydroxide.

6. A catalyst precursor according to claim 1 characterised in that the porous inorganic support material is a silica support.

7. A catalyst precursor according to claim 1 characterised in that the precursor does not comprise boric acid.

8. A process for preparing a catalyst precursor according to claim 1 comprising:
a) providing a porous inorganic support material,
b) depositing a chromium salt and an aluminium chelate according to the formula 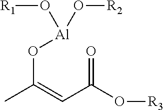
wherein R₁, R₂ and R₃ are alkyl groups with C₁-C₁₀ carbon atoms onto the porous inorganic support material from an alcoholic solution wherein the volume of the alcoholic solution is less than the total pore volume of the porous inorganic support material and
c) removing the alcohol by evaporation to form the catalyst precursor.

9. A process according to claim 8 wherein the chromium salt is chromium carboxylate, the aluminium chelate is aluminium di(C₁-C₁₀ alkoxide)acetoacetic ester chelate and the alcohol is methanol.

10. A process according to claim 9 wherein the porous inorganic support material is a silica xerogel with a pore volume from 0.8 to 4.0 cm³/g and a surface area from 200 to 800 m²/g.

11. A process according to claim 10 wherein the chromium carboxylate is chromium (III) acetate hydroxide and the aluminium di(C₁-C₁₀ alkoxide)acetoacetic ester chelate is aluminium di(sec-butoxide)ethylacetoacetate.

12. An ethylene polymerization catalyst obtained by heating the catalyst precursor according to claim 1 in a non-reducing atmosphere at a temperature in the range between 450 and 1000° C. for a time period in the range between 15 minutes and 30 hours.

13. A process for polymerization of ethylene characterized in that the polymerization is carried out in the presence of the polymerization catalyst according to claim 12.

14. An ethylene polymerization catalyst obtained by heating the catalyst precursor obtained with the process according to claim 8 in a non-reducing atmosphere at a temperature in the range between 450 and 1000° C. for a time period in the range between 15 minutes and 30 hours.

15. A process for polymerization of ethylene characterized in that the polymerization is carried out in the presence of the polymerization catalyst according to claim 14.
